(19) United States
(12) Patent Application Publication
(10) Pub. No.: US 2008/0062216 A1
(43) Pub. Date: Mar. 13, 2008

(54) Actuator chip for micro-fluid ejection device with temperature sensing and control per chip zones

(75) Inventors: Steven W. Bergstedt, Winchester, KY (US); Dave G. King, Shelbyville, KY (US); Eric D. Langevin, Lexington, KY (US); George K. Parish, Winchester, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/517,931

(22) Filed: Sep. 8, 2006

(51) Int. Cl. B41J 29/38

(52) U.S. Cl. 347/17

(57) ABSTRACT

Micro-fluid ejection device actuator chips and methods of measuring temperature of a micro-fluid ejection device actuator chip are provided. An exemplary micro-fluid ejection device includes an actuator chip for delivering fluid from the device. In one such device, one or more fluid vias include a column of actuators per at least one of the sides of the vias that are apportioned into temperature zones. A temperature sense element or resistor (TSR), per each of the zones, measures a temperature therefor. In this manner, average die or chip temperature along a length of the one or more vias can be controlled closer to a predetermined value. In various aspects, individual actuators are apportioned into zones and dedicated TSRs sense temperatures of the zones. In turn, corrective action may be caused to increase or decrease temperature as the case may be. Representative zones include three per each side of a fluid via. Mono- and multi-colored chips are also contemplated as are inkjet printers and other external devices.

### FIELD OF THE INVENTION

The present invention relates to micro-fluid ejection devices, such as inkjet printheads. In particular, in an exemplary embodiment, it relates to an actuator chip having multiple temperature sense resistors (TSRs) that allow for sensing and controlling temperature per zones of the chip. In one aspect, TSRs fairly regulate consistent temperature characteristics along a length of an actuator array. In another, TSRs are zoned per various actuators to regulate temperature. Still other aspects contemplate various circuit designs and averaging of chip temperature.

### BACKGROUND OF THE INVENTION

The art of printing images with inkjet technology is well known. In general, an image is produced by ejecting ink drops from a printhead at precise moments so they impact a print medium at a desired location. The quality and consistency of the printing, however, is dependent on a number of factors, such as ink temperature.

In this regard, the viscosity of ink varies with temperature and causes ink drops with a lower temperature to eject with a drop mass and velocity different than an ink drop with a higher temperature. Because the mass and velocity implicate where the drops are located on the print medium, if the temperature of the ink is not maintained or not maintained well, the velocity (and mass) deviate from expected calculations and drops misdirect upon firing or are malformed before firing. Both result in drop placement errors which causes poor or inconsistent print quality.

To overcome this, certain prior art devices measure temperature in printheads and undertake activities to increase or decrease the temperature, as the case may be. Typically, one or more temperature sense resistors (TSRs) are employed to measure die or chip temperature. In turn, the die temperature is correlated to the ink temperature. Also, some prior art printheads have multiple colors per a single die and therefore there are multiple ink actuator array regions having multiple corresponding temperature regions. The regions vary in temperature due to a variety of reasons, such as printing activity or distance away from the die edge, to name a few.

With reference to FIG. 1, a representative prior art actuator chip 10 includes three ink vias—a cyan ink via 12, a magenta ink via 14, and a yellow ink via 16. The cyan ink via 12 operates with the cyan heater array 18; the magenta ink via 14 operates with the magenta heater array 20; and the yellow ink via 16 operates with the yellow heater array 22. To sense temperature, three array-long TSRs 24, 26, and 28 are placed in close proximity to each of the heater arrays. That is, a first TSR 24 is situated on the left side of the cyan ink via 12 and cyan heater array 18; a second TSR 26 is situated on the left side of the magenta ink via 14 and magenta heater array 20; and a third TSR 28 is situated on the left side of the yellow ink via 16 and the yellow heater array 22. During use, the temperature of each of the arrays is measured (the ink vias act as thermal barriers between arrays) so that chip temperature can be maintained and regulated at an acceptable temperature for printing.

With reference to FIG. 2, a typical distribution of the temperature along a single array for a chip, having actuators and nozzles numbered 1-N (corresponding to FIG. 1), is depicted. In essence, a plot of the temperature of the chip or die appears as a curve 30 with the x axis being distance from nozzle numbered 1 to nozzle numbered N along the array and the y axis being temperature of the die. The shape of the curve is described as a convex distribution with a temperature maximum 32 at the middle and a temperature minimum 34 at each end of the chip, or at nozzles numbered 1 and N. In actual measurements, the temperature delta between the middle and each end has been shown to correspond to approximately 6 degrees Celsius. However, this temperature difference cannot be sensed by the TSRs of the type of FIG. 1 because the difference is located along the entire length of the array, and ink via, causing each point along the array to contribute to the change but with no separable sense points. Also, the average temperature of this distribution is shown by the dotted line. While the average temperature would be sensed by the TSR, the actual temperature at any point or nozzle has about a ±3° C. variation from the average. In turn, this variation causes a difference in the ink's temperature along the heater array and contributes to a noticeable variation in print quality if the temperature range is too large. While modern distances of arrays and ink vias are about one-half inch in length, this variation becomes increasingly important to monitor as chip dimensions change to larger printing swaths. In swaths of one-inch length, for example, variations are expected to be on the order of about ±5° C.

Accordingly, the inkjet printhead arts, and the micro-fluid ejection device arts in general, desire a solution to, for example, variations in temperature along an array length, including contemplation of trends toward larger chip dimensions. Naturally, any improvements should further contemplate good engineering practices, such as relative inexpensiveness, low complexity, ease of manufacturing, etc.

### SUMMARY OF THE INVENTION

The above-mentioned and other problems are solved, in an exemplary embodiment, by applying the principles and teachings associated with the hereinafter described micro-fluid ejection device actuator chip allowing for temperature sensing and control per chip zones. Representatively, an actuator chip includes one or more fluid (e.g., ink) vias for delivering fluid from the device. On at least one side per via, a column of actuators are apportioned into temperature zones. Temperature sense elements or resistors (collectively TSRs), at least one per each of the zones, can be used to measure temperatures so that chip temperature, generally along a length of the one or more vias, is controlled closer to a predetermined value.

In various aspects, individual actuators are apportioned into zones. The number of actuators per zone varies, but can be substantially equal to a total number of actuators in the column of actuators divided by the number of the zones. Representatively, if a column includes 312 actuators, and the number of zones is three, there would be 312÷3 or 104 actuators per zone.

In other aspects, the zones correspond to three in number and extend end-to-end, substantially parallel to the longitudinal extent of the vias. The TSRs are also three in number and are dedicated per zone. Upon measuring temperature, a TSR controller might cause a corrective action to occur to increase or decrease temperature of the zone. Sending a fire pulse to one or more of the actuators with a duration too short to eject fluid is a representative course of action for increasing temperature. Preventing or delaying a firing pulse from being sent to an actuator to otherwise eject fluid is a representative course of action for decreasing temperature.

In still other aspects, the actuator chip has multiple I/O terminals, in the form of bond pads, and such electrically connect the device (e.g., a printhead) to a controller of an external device, such as an inkjet printer. A plurality of TSRs of the actuator chip each has an output provided to only a single one of the bond pads. In this manner, chip I/O count over the prior art is improved.

Inkjet printheads, containing actuator chips, and printers or other external devices, containing printheads, are also disclosed.

These and other embodiments, aspects, advantages, and features of exemplary embodiments of the present invention will be set forth in the description which follows, and in part will become apparent to those of ordinary skill in the art by reference to the following description of the invention and referenced drawings or by practice of the invention. The aspects, advantages, and features of the exemplary embodiments of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the prior art of a representative actuator chip and attendant TSR arrangement;

FIG. 2 is a graph in accordance with the prior art of a representative temperature distribution per actuator array according to TSR measurements of the chip of FIG. 1;

FIG. 3 is a perspective view in accordance with the teachings of the present invention of an inkjet printhead and actuator chip having temperature sense resistor(s) (TSRs) per chip zones;

FIG. 4 is a perspective view in accordance with the teachings of the present invention of an exemplary device for use with the inkjet printhead and actuator chip of FIG. 3;

FIG. 5 is a diagrammatic circuit in accordance with the teachings of the present invention of a representative actuator chip having multiple TSRs per chip zones;

FIG. 6 is a graph in accordance with the teachings of the present invention of a representative temperature distribution per actuator array relative to the TSR arrangement of FIG. 5;

FIGS. 7A-7C are diagrammatic views in accordance with the teachings of the present invention of representative columns of actuators in an actuator chip for zoning per TSR; and

FIGS. 8-10 are diagrammatic views in accordance with the teachings of the present invention of representative multiple TSR's and control per zones of either a mono- or multi-via actuator chip.

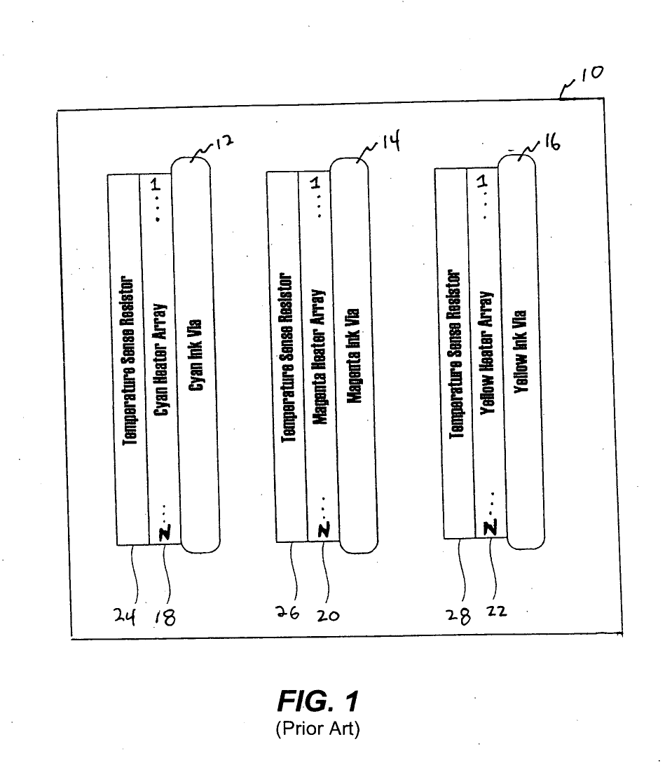

### DETAILED DESCRIPTION OF EXEMPLARY EMBODIMENTS

In the following detailed description of exemplary embodiments, reference is made to the accompanying drawings (with like numerals representing like elements) that form a part hereof, and in which is shown by way of illustration, specific embodiments in which the invention may be practiced. These embodiments are described in sufficient detail to enable those skilled in the art to practice the invention, and it is to be understood that other embodiments may be utilized and that process, electrical, mechanical or other changes may be made without departing from the scope of the present invention. Appreciating the actuator chip of the invention typifies a wafer or substrate, such contemplates ceramic and silicon substrates utilizing, or not, silicon-on-sapphire (SOS) technology, silicon-on-insulator (SOI) technology, thin film transistor (TFT) technology, doped and undoped semiconductors, epitaxial layers of silicon supported by a base semiconductor structure, as well as other structures hereinafter invented or well known to one skilled in the art. The following detailed description is, therefore, not to be taken in a limiting sense, and the scope of the present invention is defined only by the appended claims and their equivalents. In accordance therewith, an inkjet printhead actuator chip having temperature sensing and control per chip zones is hereinafter described.

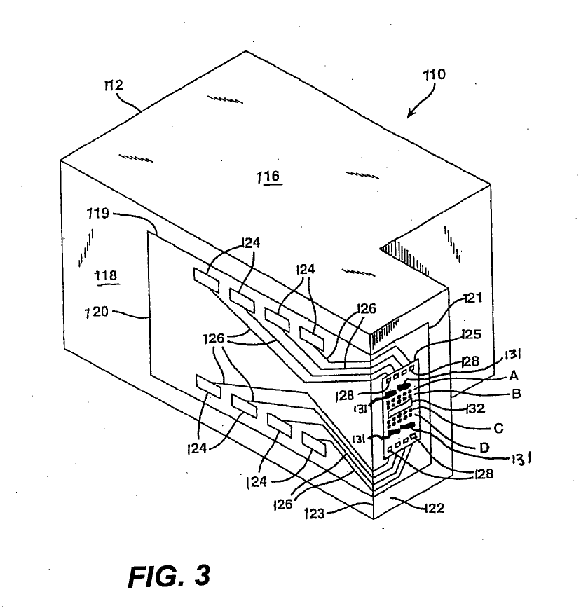

In FIG. 3, an inkjet printhead is shown generally as 110. It includes an actuator chip 125 having multiple temperature sense elements or resistors (TSR(s) hereafter) 131 arranged per zones of the chip, especially per zones corresponding to ink actuators arranged in columns A-D. During use, the TSRs, at least one per each of the zones, measure temperatures so that chip temperature, generally along an entire length of one or more ink vias 132 can be controlled close to a predetermined value. Arrangement and other details are described below with reference to this and other figures.

The printhead has a housing 112 with a shape that depends mostly upon the shape of the external device, e.g., printer, fax machine, scanner, copier, photo-printer, plotter, all-in-one, etc., that contains and uses it. The housing has at least one internal compartment 116 for holding an initial or refillable supply of ink. In one embodiment, the compartment contemplates a single chamber holding a supply of black, cyan, magenta or yellow ink. In other embodiments, it contemplates multiple chambers containing multiple different or same colored inks. Its compartment may also exist locally integrated within a housing 112 (as shown) or separable from the housing 112 and/or printhead 110 and connected via tubes or other conduits, for example.

At one surface 118 of the housing 112, a portion 119 of a flexible circuit, especially a tape automated bond (TAB) circuit 120, is adhered. At 121, another portion is adhered to surface 122. Electrically, the TAB circuit 120 supports a plurality of input/output (I/O) connectors 124 for connecting an actuator chip 125, such as a heater chip, to the external device during use. Pluralities of electrical conductors 126 exist on the TAB circuit to connect and short the I/O connectors 124 to the terminals (bond pads 128) of the actuator chip 125 and skilled artisans know various techniques for facilitating this. Also, eight I/O connectors 124, electrical conductors 126 and bond pads 128 are shown for simplicity, but present day printheads have larger quantities and any number is equally embraced herein. The number of connectors, conductors and bond pads, while shown as equal to one another, may also vary unequally in actual embodiments.

At 132, the actuator chip 125 contains at least one ink via that fluidly connects to the ink of the compartment 116. During manufacturing, the actuator chip 125 is attached to the housing with any of a variety of adhesives, epoxies, etc. To eject ink, the actuator chip contains columns (column A-column D) of fluid firing actuators, such as thermal heaters. In other chips, the fluid firing actuators embody piezoelectric elements, MEMs devices, transducers or other. In either, this crowded figure simplifies the actuators as four columns of five dots or darkened circles but in practice might number several dozen, hundred or thousand. Also, vertically adjacent ones of the actuators may or may not have a lateral spacing gap or stagger there between. If practiced, typical actuator pitch spacing includes 1/300^{th}, 1/600^{th}, 1/1200^{th}, or 1/2400^{th} of an inch along the longitudinal extent of a via. Further, individual actuators are formed as a series of thin film layers made via growth, deposition, masking, patterning, photolithography and/or etching or other processing steps on a substrate, such as silicon. A nozzle member with pluralities of nozzle holes, not shown, is adhered to or fabricated as another thin film layer on the actuator chip such that the nozzle holes generally align with and are positioned above the actuators to eject ink.

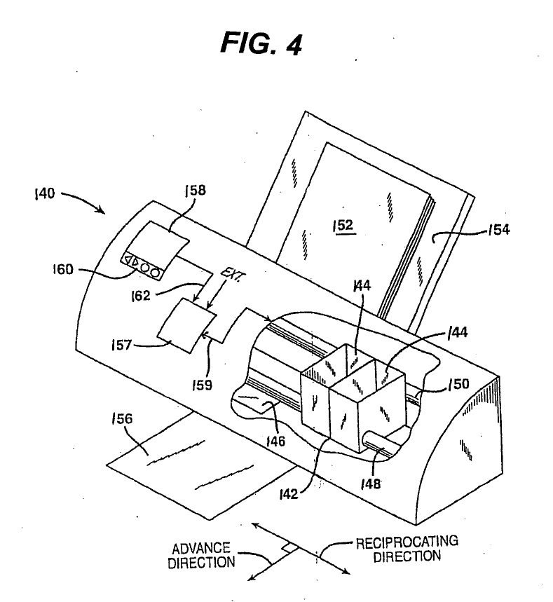

With reference to FIG. 4, an exemplary external device in the form of an inkjet printer contains the printhead 110 during use and is shown generally as 140. It includes a carriage 142 having a plurality of slots 144 for containing one or more printheads 110. The carriage 142 reciprocates (in accordance with an output 159 of a controller 157) along a shaft 148 above a print zone 146 by a motive force supplied to a drive belt 150 as is well known in the art. The reciprocation of the carriage 142 occurs relative to a print medium, such as a sheet of paper 152, which advances in the printer 140 along a paper path from an input tray 154, through the print zone 146, to an output tray 156.

While in the print zone, the carriage 142 reciprocates in a Reciprocating Direction and such is generally perpendicular to an Advance Direction (shown by the arrows) in which the paper 152 is advanced. Ink from compartment 116 (FIG. 3) is caused to eject in a drop(s) from the actuator chip at times pursuant to commands of a printer microprocessor or other controller 157. The timing corresponds to a pattern of pixels of the image being printed. Often times, the patterns are generated in devices electrically connected to the controller 157 (via Ext. input) that reside external to the printer and include, but are not limited to, a computer, a scanner, a camera, a visual display unit, a personal data assistant, or other.

To emit a single drop of ink, an actuator, such as a heater (e.g., one of the dots in columns A-D, FIG. 3) is provided with a small amount of current (such as through a combination of addressing and pulsing) to rapidly heat a small volume of ink. This causes a portion of the ink to vaporize in a local ink chamber between the heater and the nozzle member, and eject a drop(s) of the ink through a nozzle(s) in the nozzle member toward the print medium. A representative fire pulse used to provide such a current comprises a single or split firing pulse that is received at the actuator chip on a terminal (e.g., bond pad 128) (or decoded at the heater chip) from connections allocated between the bond pad 128, the electrical conductors 126, the I/O connectors 124 and the controller 157. Internal actuator chip wiring conveys the fire pulse from the input terminal to one or more of many of the actuators. A control panel 158, having user selection interface 160, may also accompany the printer and serve to provide user input 162 to the controller 157 for additional printer capabilities and robustness.

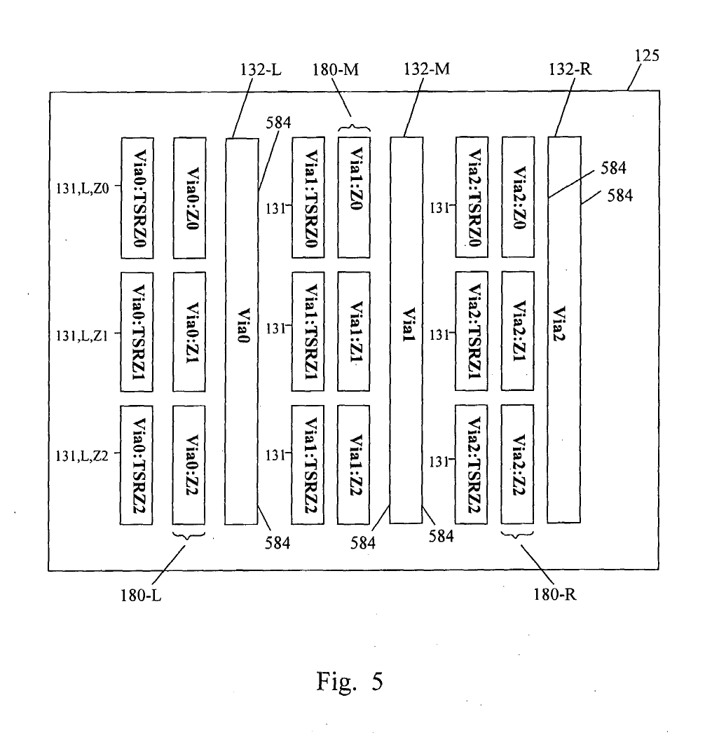

With reference to FIG. 5, an exemplary actuator chip 125 includes three substantially parallel ink vias 132 (132L, 132M and 132R per a respective left, middle and right side of the chip, alternatively labeled via 0, via 1 and via 2) each having sides 584 thereof defining a longitudinal extent of the via. Along at least one of the sides of each ink via is a column of actuators 180L, 180M, 180R for ejecting ink during use upon. Also, each of the columns is divided functionally into temperature zones. In this instance, three zones Z0, Z1 and Z2 exist and such is populated with individual actuators as will be described below. Also, corresponding to each of the zones, is an attendant TSR 131 (with the leftmost via in this crowded figure having additional reference labeling L for leftmost via, and zone Z0, Z1, or Z3 corresponding to actuator zones Z0, Z1, or Z3). Illustratively, each TSR 131 is also dedicated per the actuators of its attendant zone, but need not be since individual actuators near the boundary between zones may have some thermal influence on TSRs not corresponding to its zone. During use, each TSR measures a temperature for its respective zone. In a representative example, column 180L includes 312 actuators, and since the number of zones is three, there would be 104 or 312÷3 actuators per zone. For a top 104 actuators of the column, TSR 131, L, Z0 measures temperature and reports it to a TSR controller. Upon measuring, the controller might determine that a corrective action needs to occur for those 104 actuators to increase or decrease temperature of the zone so that better print quality results. In this regard, it is contemplated the controller or other structure will send a fire pulse to one or more of the 104 actuators with a duration too short to eject ink to increase temperature. On the other hand, to decrease temperature, the controller or other structure might prevent or delay an actual firing pulse from being sent to one of the 104 actuators. In the former, more firing pulses translates to hotter actuators, in turn, to warmer zone Z0 temperatures. In the latter, fewer firing pulses translates to cooler actuators, in turn, to lower zone Z0 temperatures. Of course, heating or cooling 104 actuators in one zone does not mean that heating or cooling 104 actuators is required in the next zone for the same ink via. It also does not mean that heating or cooling is required for an adjacent ink via. In other words, relative pinpoint control of the temperature of a single ink via is now enabled.

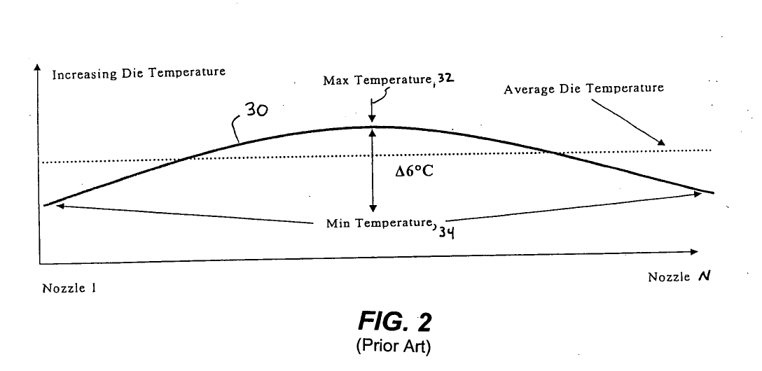

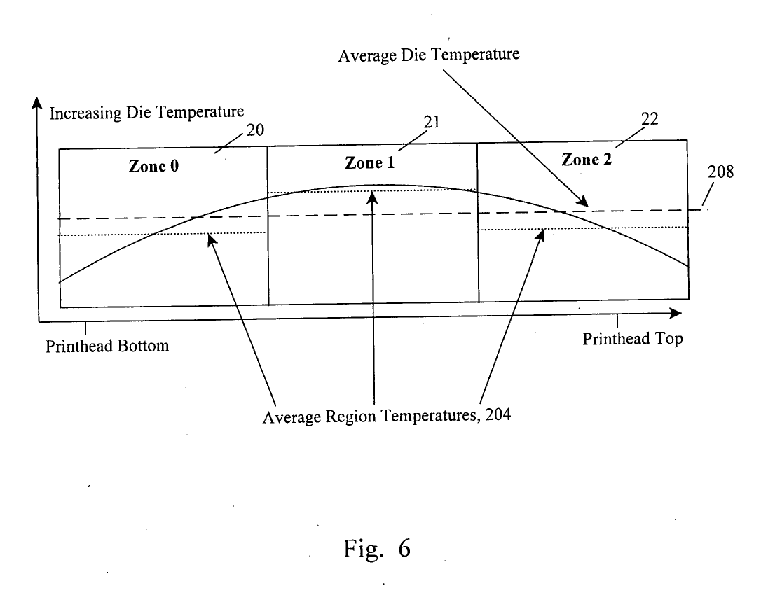

With reference to FIG. 6, the improvement of this zone control is graphically demonstrated by reanalyzing the data presented in FIG. 2. Namely, the data shown in FIG. 6 is given with the zone regions 0-2 superimposed over the temperature distribution. The zones are also distributed along the length of the column or array of actuators by dividing it up into thirds along its length. The zone TSRs 131 average the temperatures in their respective regions and these averages appear as lines 200, 202 and 204. As seen, the average temperature for zone 1 is clearly higher than the average zone temperature for zones 0 and 2. Zone 1, therefore, is operating at a temperature higher than the predetermined or desired average temperature 208 and the control for this zone would deactivate to reduce the temperature. Zones 0 and 2, on the other hand, are operating below the desired temperature 208 and so their zones would be activated to increase temperature. In this regard, it is estimated that improvement for this temperature distribution is ±1.5 degrees Celsius or about a 50% improvement over the entire column's average temperature of the prior art. Naturally, more or less zones can be added or subtracted as needed depending on the temperature distribution and the resolution required. In the event of future one inch printhead dies, it might even require as many as eight zones to accurately sense temperature.

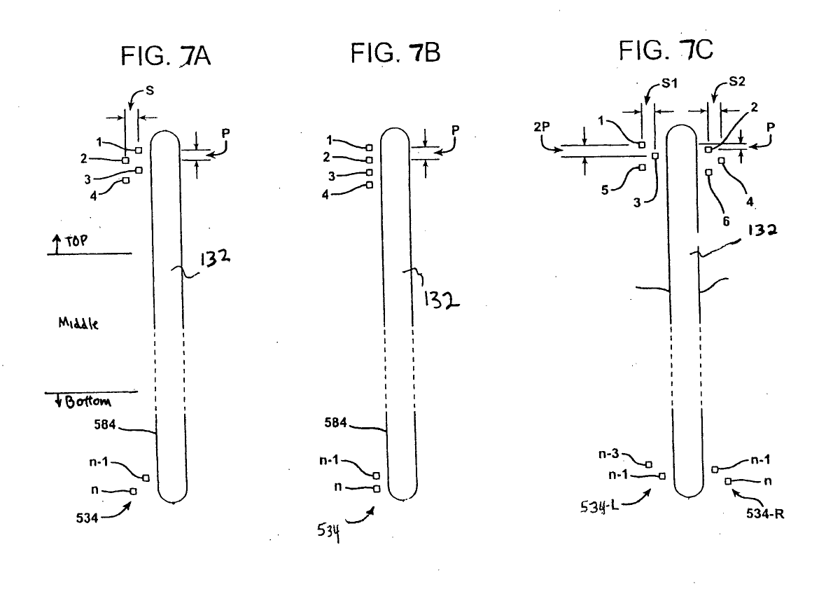

With reference to FIGS. 7A-7C, a column of fluid firing actuators is made up of individual actuators in a variety of forms. For example, FIG. 7A shows actuators 1 through n of a given column 534 existing exclusively along one side 584 of an ink via 132. As seen, a slight horizontal spacing gap S exists between vertically adjacent ones of the actuators and such is on the order of about 3/1200^{th} of an inch. On the other hand, a vertical distance or pitch P exists between vertically adjacent actuators and such is on the order of about 1/300^{th}, 1/600^{th}, 1/1200^{th}, or 1/2400^{th} of an inch. In this regard, the amount of actuators in a zone is determined by the total number of actuators, e.g., n, divided by the number of zones. In the event the division results in a decimal number, the actual number of actuators per zone is then representatively rounded up or down to a nearest whole number. It is possible, of course, that zones will have unequal numbers of actuators. Alternately, zones of actuators can be configured such that the even numbered actuators (those closest to via side 584) form a whole or part of a zone while the odd numbered actuators (those farthest from via side 584) form a whole or part of another zone, as opposed to simply dividing zones according to the top, middle and bottom labels. In FIG. 7B, vertically adjacent ones of actuators in column 534 are substantially linearly aligned with one another along an entirety of the length of the ink via 132. Although the actuators of FIGS. 7A and 7B have been shown exclusively on a left side of the ink via, alternate embodiments of the invention contemplate their location on the right side or on both sides. In FIG. 7C, a representative embodiment of actuators on both sides of the ink via includes those in columns 534-L and 534-R. In this instance, each column has a spacing gap S1 and S2 between vertically adjacent ones of actuators and both are substantially equal. Also, pitch P is given between sequentially numbered actuators such that a twice pitch (2P) vertical spacing exists between sequential odd or even numbered actuators.

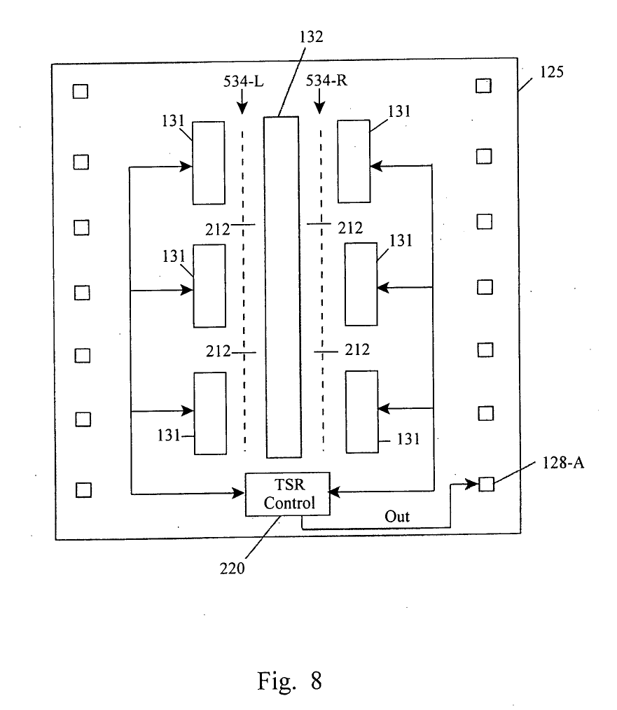

With reference to FIG. 8, an actuator chip 125 with a mono via 132 is given. It includes multiple TSRs 131 per each of a variety of zones of a column of actuators (534-L or 534-R, as the case may be) divided by tick marks 212 corresponding roughly to thirds of the length of the column. A TSR controller 220 also exists and communicates individually and collectively with the individual TSRs to coordinate overall chip temperature. A single-point output on bond pad 128-A of the controller 220 is also provided. By incorporation by reference, the subject matter of various circuitry and arrangements for accomplishing this is provided in a co-pending application having Ser. No. 11/427,174, filed on Jun. 28, 2006, entitled “Actuator Chip for Inkjet Printhead With Temperature Sense Resistors Having Current, Single Point-Output,” and having a common assignee in Lexmark International, Inc.

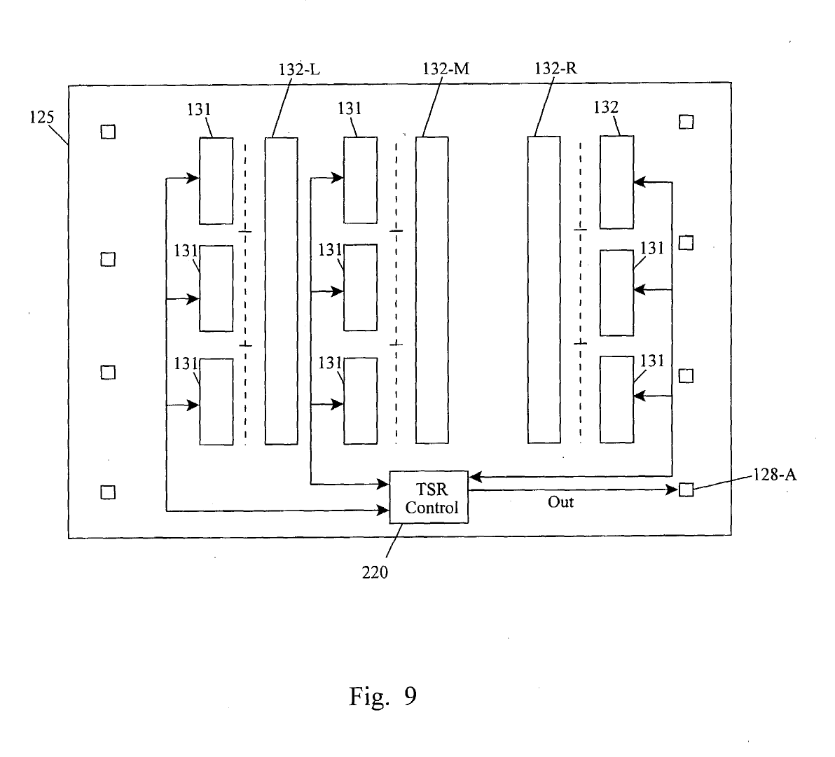

With reference to FIG. 9, the notion of the TSR controller is extended to a multi-via actuator chip 125 having three substantially parallel vias 132-L, 132-M and 132-R. In this regard, multiple vias and/or multiple ink colors can be controlled simultaneously. In comparison to FIG. 8, skilled artisans will observe that multiple TSRs and attendant zones are established for both sides of a single, mono-via, whereas FIG. 9 only depicts TSRs and attendant zones per a single side of any given via. Also, the zones and TSRs can occur on either a left or right side of a given via and a single chip 125 may include all combinations thereof as shown.

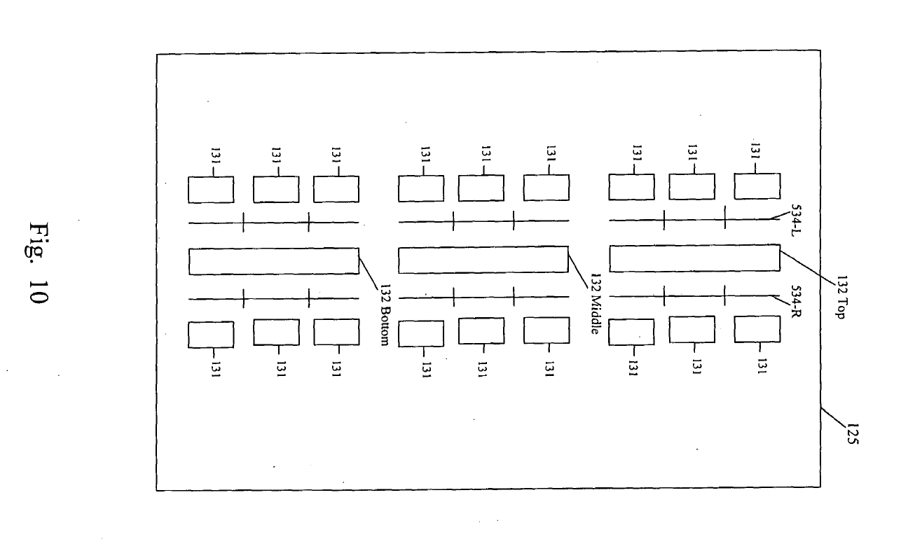

In FIG. 10, an exemplary actuator chip 125 includes three end-to-end vias 132-top, -middle, and -bottom, with pluralities of TSRs 131 arranged in vertical zones per columns of actuators. Also, the zones (separated by tick marks in the column 534) are arranged end-to-end to generally parallel the longitudinal extent of the vias as defined by theirs sides. In turn, the TSRs 131 are stacked end-to-end with one another and parallel the longitudinal extent of the vias. This is also true in FIGS. 8 and 9.

While not shown, it is representative that the output signal of any TSR be correlated to ink temperature so that appropriate predetermined zone temperatures are known during printing. The correlation can embody any form, including a look-up table, and such can be stored in memory of an external device controller, for example, for convenient access during use.

Finally, the foregoing description is presented for purposes of illustration and description of the various aspects of the invention. The descriptions are not intended, however, to be exhaustive or to limit the invention to the precise form disclosed. Accordingly, the embodiments described above were chosen to provide the best illustration of the principles of the invention and its practical application to thereby enable one of ordinary skill in the art to utilize the invention in various embodiments and with various modifications, such as combinations of the foregoing, as are suited to the particular use contemplated. All such modifications and variations are within the scope of the invention as determined by the appended claims when interpreted in accordance with the breadth to which they are fairly, legally and equitably entitled.

What is claimed:

1. A micro-fluid ejection device actuator chip, comprising:
a fluid via;
a column of actuators per at least one side of the via divided functionally into a plurality of zones; and
a temperature sense element per each of the zones, each of the temperature sense elements being capable of measuring a temperature for a respective one of the zones, wherein the temperatures of the zones can be substantially controlled.

2. The actuator chip of claim 1, wherein a number of actuators per each of the zones is substantially equal to a total number of actuators in the column of actuators divided by the number of the zones.

3. The actuator chip of claim 1, wherein the plurality of zones is equal to three.

4. The actuator chip of claim 3, wherein the three zones are substantially parallel with a longitudinal extent of the via.

5. The actuator chip of claim 3, wherein the three zones are substantially end-to-end with one another along the at least one side of the via.

6. The actuator chip of claim 1, further including two more vias each with a column of actuators per at least one side of the vias divided functionally into a plurality of additional zones.

7. The actuator chip of claim 6, wherein the plurality of additional zones is equal to three per each of the two more vias.

8. The actuator chip of claim 1, further including temperature zones per either side of the via.

9. A micro-fluid ejection device actuator chip, comprising:
at least two substantially parallel fluid vias each having sides defining a longitudinal extent;
a column of actuators per at least one of the sides of each of the vias divided functionally into at least three zones; and
a temperature sense element per each of the at least three zones, each of the temperature sense elements being capable of measuring a temperature for a respective one of the zones, wherein the temperatures of the at least three zones can be substantially controlled.

10. The actuator chip of claim 9, wherein the zones substantially parallel the longitudinal extent.

11. The actuator chip of claim 9, further including a controller supplying an output to a single bond pad of the chip.

12. The actuator chip of claim 9, wherein the at least three zones are substantially end-to-end with one another along the at least one of the sides of each of the vias.

13. The actuator chip of claim 9, further including only one temperature sense element per the each of the at least three zones.

14. A method of measuring temperature of a micro-fluid ejection device actuator chip having at least one fluid via and a column of actuators per at least one side of the at least one via, comprising:
apportioning individual actuators of the column of actuators into at least one temperature zone of a plurality of temperature zones; and
sensing temperatures for the plurality of temperature zones per temperature sense elements, wherein each zone of the plurality of temperature zones has a temperature sensed by a respective one of the temperature sense elements.

15. The method of claim 14, further including associating an exclusive temperature sense element to each of the plurality of temperature zones.

16. The method of claim 15, further including causing an increase or decrease in temperature of the plurality of temperature zones in response to the sensing.

17. The method of claim 16, wherein the causing further includes sending a fire pulse to at least one of the individual actuators of a duration too short to eject fluid.

18. The method of claim 15, wherein the apportioning further includes associating the column of actuators according to a first, middle and last third thereof.

19. The method of claim 18, further including providing a dedicated temperature sense element to the associated first, middle and last third of the column of actuators.

20. The method of claim 15, further including averaging a temperature of the actuator chip from the sensed temperatures of the plurality of temperature zones.
